(19) United States
(12) Patent Application Publication
(10) Pub. No.: US 2026/0275025 A1
(43) Pub. Date: Sep. 17, 2026

(54) CURABLE COMPOSITION HAVING AN ALDEHYDE-FUNCTIONAL POLYMER

(71) Applicant: SIKA TECHNOLOGY AG, Baar (CH)

(72) Inventors: Edis KASEMI, Zürich (CH); Andreas KRAMER, Zürich (CH); Urs BURCKHARDT, Zürich (CH); Hans HÄBERLE, Gailingent (CH); Anna DEEVA, Lenzburg (CH)

(73) Assignee: SIKA TECHNOLOGY AG, Baar (CH)

(21) Appl. No.: 19/473,547

(22) PCT Filed: Jun. 18, 2024
(86) PCT No.: PCT/EP2024/067004

§ 371 Date: Oct. 8, 2025

(30) Foreign Application Priority Data
Jun. 21, 2023 (EP) 23180644.9

(51) Int. Cl. C08G 18/87; C08G 18/84; C08K 3/04; C08K 3/22; C08K 3/26; C08K 3/34; C08K 3/36; C08K 5/548; C08K 13/08

(52) U.S. Cl. CPC C08G 18/87; C08K 3/04; C08K 3/346; C08K 3/36; C08K 5/548; C08G 18/84; C08G 2150/00; C08G 2170/00; C08G 2190/00; C08K 2003/2227; C08K 2003/265; C08K 13/08

(57) ABSTRACT

A curable composition comprising:—a first component containing at least one aldehyde-group-containing polymer having a hydrocarbon, polyether or polyester backbone; and—a second component containing at least one compound having two or more thiol groups. The composition cures in ambient conditions, irrespective of humidity, rapidly and without problems to form a resilient polymer having high strength and ductility, good adhesion properties and good stability with respect to heat and water. The composition is particularly suitable for use as a resilient adhesive, sealant or coating having a high level of robustness during production, storage, processing and use.

### TECHNICAL FIELD

The invention relates to reactive polymer compositions and to the use thereof as room-temperature-curable elastic adhesives, sealants or coatings.

### PRIOR ART

Reactive polymer compositions that are curable at room temperature and can be used as adhesives, sealants or coatings with elastic properties are known. Polyurethane systems that cure through the reaction of isocyanate groups with polyols and/or moisture and form particularly highly elastic polymers are in widespread use. The industrial formulation, production, and use of polyurethane systems represents a series of challenges. The systems usually contain considerable amounts of monomeric diisocyanates, which can irritate the eyes, skin, and mucous membranes. The moisture sensitivity of the isocyanate groups can result in premature crosslinking reactions associated with an increase in viscosity as far as gelation, and thus adversely affect shelf life or storage stability.

In the case of systems formulated in one-component form, the water required for curing must penetrate from the outside in the form of atmospheric moisture, which makes them difficult to use in thick layers or between substrates impermeable to moisture. A problem in the case of two-component systems comprising a polyol component and an isocyanate component is that the isocyanate groups can react not just with the hydroxyl groups of the polyols but also with any water present, which can cause blistering and incompletely crosslinked polymers.

Likewise widely used are reactive polymer compositions based on silane-functional polymers or silicones. These polymer systems cure through hydrolysis and condensation of silane groups, with the release of alcohols, in particular methanol or ethanol, or oximes, which are toxic and give rise to emissions; in addition, they usually contain large amounts of low-molecular-weight silanes, which are likewise harmful to health. Because of the moisture sensitivity of the silane groups, these polymer systems are also demanding in terms of production and use and do not always lead to the desired results.

Polym. Chem., 2019, 10, 219, describes the crosslinking of mercapto-group-containing silicones with aldehydes such as benzaldehyde or terephthaldehyde.

Such polymer systems containing polysiloxane chains are not paintable and are poorly compatible with many ingredients and substrates. They are therefore suitable only for special uses.

U.S. Pat. No. 3,392,148 describes polyurethanes with aldehyde end groups that are solid at room temperature and their curing by heating in the presence of an acidic catalyst.

US 2023/044535 describes polyimines from the reaction of poly(urethane)aldehydes and polyetheramines and use thereof in moisture-curing polyurethane compositions.

### SUMMARY OF THE INVENTION

It is an object of the present invention to provide a novel polymer composition that is curable at room temperature and that is suitable as elastic adhesive, sealant or coating and overcomes the disadvantages of the known polymer systems.

This object is achieved by a curable composition as described in claim 1. The composition comprises a first component comprising at least one aldehyde-group-containing polymer having a hydrocarbon, polyether or polyester backbone and a second component comprising at least one compound having two or more thiol groups. The composition according to the invention has a number of surprising and advantageous properties compared to polymer systems of the prior art.

The composition is not sensitive to moisture and allows a high degree of freedom in formulation, since it is possible in both components to use additives commonly used in curable compositions without this causing problems with the storage stability of the respective component. Furthermore, the composition has good processibility under ambient conditions while typically needing hardly any organic solvent for dissolution or thinning and no water for emulsification or dispersion of constituents. The composition cures surprisingly rapidly and without problems under ambient conditions, irrespective of humidity, and without giving rise to emissions. Moreover, the curing using commercially available acids such as toluenesulfonic acid or dodecylbenzenesulfonic acid is very readily controllable, which means that no metal-containing catalysts are necessary. Curing gives rise to a non-tacky elastic polymer of high strength and extensibility, with good tear propagation resistance and good adhesion properties.

Surprisingly, the composition of the invention comprising an aldehyde-group-containing polymer and a thiol as curing agent shows significantly better properties compared to the reverse system having a mercapto-group-containing polymer and an aldehyde as curing agent. This is not apparent from the prior art.

In a preferred embodiment of the invention, the composition comprises at least one filler selected from aluminum oxide, aluminum hydroxide, zinc oxide, and zinc hydroxide, especially aluminum hydroxide. After curing, such a composition shows particularly high strength coupled with high extensibility and surprisingly good stability to heat and moisture.

The curable composition is particularly suitable for use as an elastic adhesive, sealant or coating.

Further aspects of the invention are the subject of further independent claims.

Particularly preferred embodiments of the invention are the subject of the dependent claims.

### Ways of Executing the Invention

The invention provides a curable composition comprising
a first component comprising at least one aldehyde-group-containing polymer having a hydrocarbon, polyether or polyester backbone, and
a second component comprising at least one compound having two or more thiol groups.

“Molecular weight” refers to the molar mass (in grams per mole) of a molecule.

“Average molecular weight” refers to the number-average molecular weight (Mₙ) of a polydisperse mixture of oligomeric or polymeric molecules. It is determined by gel-permeation chromatography (GPC) against polystyrene as standard.

Substance names beginning with “poly”, such as polymercaptan, polyaldehyde, polyisocyanate or polyol, refer to substances formally containing two or more of the functional groups that occur in their name per molecule.

A “storage stable” composition refers to one that can be stored at room temperature in a suitable container over a prolonged period, typically over at least 3 months up to 6 months or more, without this storage resulting in any change in its application or use properties to an extent relevant to its use.

A “filler” refers to a pulverulent substance that is solid at room temperature and is not soluble in the curable composition.

“Room temperature” refers to a temperature of 23° C.

All industry standards and norms mentioned in this document relate to the versions valid at the date of first filing.

Percentages by weight (% by weight) refer to proportions by mass of a constituent of a composition or a molecule based on the total composition or the total molecule, unless otherwise stated. The terms “mass” and “weight” are used synonymously in the present document.

The first and second components of the curable composition are on their own storage-stable and are stored in separate containers until they are mixed with one another shortly before or during application.

The aldehyde-group-containing polymer is preferably liquid at room temperature.

In particular, it has a viscosity at 20° C. of 0.5 to 1000 Pa·s, preferably 1 to 500 Pa·s, especially 2 to 200 Pa·s, measured by cone-plate viscometer with cone diameter 10 mm, cone angle 1°, cone tip-plate distance 0.05 mm, and shear rate 10 s⁻¹. Such polymers are easy to work with at ambient temperatures even without addition of solvents or thinners.

The aldehyde-group-containing polymer has a hydrocarbon, polyether or polyester backbone.

Particularly suitable as a hydrocarbon backbone are hydrocarbon chains or hydrocarbon chains substituted with acrylate groups. Preference is given to hydrocarbon chains, especially polybutadiene chains.

Particularly suitable as a polyether backbone are poly(oxyalkylene) chains.

Preference as poly(oxyalkylene) is given to poly(oxyethylene), poly(oxy-1,2-propylene), poly(oxy-1,3-propylene), poly(oxy-1,4-butylene), poly(oxy-1,2-butylene) or a mixed form of these poly(oxyalkylenes). Preference among these is given to poly(oxy-1,2-propylene), poly(oxy-1,3-propylene) or poly(oxy-1,4-butylene), especially poly(oxy-1,2-propylene), it being possible for a poly(oxy-1,2-propylene) backbone to include a content of poly(oxyethylene) units of 0% to 20% by weight based on the poly(oxyalkylene) backbone, especially at the chain ends.

Suitable as a polyester backbone are especially polyester chains derived from lactones or from di- or tricarboxylic acids and di- or triols, and also chains containing triglyceride.

Preferred di- or tricarboxylic acids are selected from succinic acid, glutaric acid, adipic acid, pimelic acid, suberic acid, azelaic acid, sebacic acid, dodecanedicarboxylic acid, maleic acid, fumaric acid, phthalic acid, isophthalic acid, terephthalic acid, hexahydrophthalic acid, dimer fatty acids, and trimer fatty acids.

Preferred diols or triols are selected from ethane-1,2-diol, diethylene glycol, propane-1,2-diol, dipropylene glycol, butane-1,4-diol, pentane-1,5-diol, hexane-1,6-diol, neopentyl glycol, cyclohexane-1,3-dimethanol, cyclohexane-1,4-dimethanol, trimethylolpropane, glycerol, castor oil, dimer fatty alcohols, and trimer fatty alcohols.

Particular preference is given to polyester chains containing esters of dimer fatty acids, trimer fatty acids, adipic acid and/or terephthalic acid, especially esters of dimer or trimer fatty acids.

Particular preference is given also to polyester chains containing triglycerides, especially triglycerides derived from castor oil, derivatives of castor oil or vegetable oils.

Preference is given to aldehyde-group-containing polymers having a polyether or polyester backbone.

Particular preference is given to aldehyde-group-containing polymers having a polyether backbone. Such polymers are easily obtainable, have relatively low viscosity, and permit high extensibility in the cured composition.

Particular preference is given also to aldehyde-group-containing polymers having a polyester backbone containing esters of di- or trimer fatty acids or triglycerides. Such polymers are particularly sustainable.

Preferably, the aldehyde-group-containing polymer has an average molecular weight Mₙ of from 500 to 20 000 g/mol, preferably 1000 to 15 000 g/mol, more preferably 2000 to 10 000 g/mol, in particular 3000 to 8000 g/mol. This permits cured compositions having high extensibility, strength, and stability.

Preferably, the aldehyde-group-containing polymer has an average aldehyde equivalent weight of from 250 to 6000 g/eq, preferably 500 to 5000 g/eq, more preferably 800 to 4000 g/mol, in particular 1500 to 3000 g/eq.

Preferably, the aldehyde-group-containing polymer has an average aldehyde functionality of from 1.6 to 6, preferably 1.7 to 4, more preferably 1.8 to 3.

The aldehyde groups of the aldehyde-group-containing polymer are preferably each attached to an aromatic or heteroaromatic ring. This permits particularly reliable and rapid curing.

The aldehyde groups are preferably attached to a furan ring, benzene ring or to a naphthalene backbone.

A particularly preferred aldehyde-group-containing polymer is a polymer containing urethane groups that is liquid at room temperature and has an average aldehyde functionality of 1.7 to 4, in particular 1.8 to 3, and an average molecular weight Mₙ of 1000 to 20 000 g/mol, preferably 2000 to 10 000 g/mol, in particular 3000 to 8000 g/mol, measured by gel-permeation chromatography (GPC) against polystyrene as standard.

The aldehyde-group-containing polymer is preferably a reaction product from the reaction of at least one hydroxyaldehyde with at least one isocyanate-group-containing polymer. The isocyanate-group-containing polymer here has a hydrocarbon, polyether or polyester backbone. In particular, the isocyanate-group-containing polymer is derived from a polyol selected from hydrocarbon polyols, polyether polyols, polyester polyols, and polyether polyester polyols.

The isocyanate-group-containing polymer is preferably liquid at room temperature, in particular having a viscosity at 20° C. of 0.2 to 500 Pa·s, preferably 0.5 to 300 Pa·s, in particular 1 to 150 Pa·s, measured using a cone-plate viscometer with cone diameter 10 mm, cone angle 1°, cone tip-plate distance 0.05 mm, and shear rate 10 s⁻¹.

Preferably, the isocyanate-group-containing polymer has an NCO content of from 0.5% to 8.4% by weight, preferably 0.7% to 5.5% by weight, in particular 1% to 3.5% by weight.

Preferably, the hydroxyaldehyde and the isocyanate-group-containing polymer are reacted in an OH/NCO ratio of 1/1 to 1.2/1 at a temperature of 40 to 140° C., preferably 60 to 120° C., optionally in the presence of a suitable catalyst.

The hydroxyaldehyde is preferably a hydroxyaldehyde having a molecular weight of from 60 to 500 g/mol and at least one aldehyde group attached to an aromatic carbon atom. The hydroxyl group of the hydroxyaldehyde is preferably attached to an aliphatic carbon atom.

The hydroxyaldehyde is preferably selected from the group consisting of 5-hydroxymethylfurfural, 2-(2-hydroxyethoxy)benzaldehyde, higher ethoxylated 2-hydroxybenzaldehyde, 3-(2-hydroxyethoxy)benzaldehyde, higher ethoxylated 3-hydroxybenzaldehyde, 4-(2-hydroxyethoxy)benzaldehyde, higher ethoxylated 4-hydroxybenzaldehyde, 4-(2-hydroxyethoxy)-3-methoxybenzaldehyde, higher ethoxylated 4-hydroxy-3-methoxybenzaldehyde, propoxylated 2-hydroxybenzaldehyde, propoxylated 3-hydroxybenzaldehyde, propoxylated 4-hydroxybenzaldehyde, propoxylated 4-hydroxy-3-methoxybenzaldehyde, 4,4′-(2-hydroxypropane-1,3-diyl)bis(oxy)bis(benzaldehyde), and 4,4′-(2-hydroxypropane-1,3-diyl)bis(oxy)bis(3-methoxybenzaldehyde).

Preference among these is given to 5-hydroxymethylfurfural, 2-(2-hydroxyethoxy)benzaldehyde, 3-(2-hydroxyethoxy)benzaldehyde, 4-(2-hydroxyethoxy)benzaldehyde or 4-(2-hydroxyethoxy)-3-methoxybenzaldehyde, especially 5-hydroxymethylfurfural or 3-(2-hydroxyethoxy)benzaldehyde. These hydroxyaldehydes are obtainable in simple processes and permit aldehyde-group-containing polymers having a viscosity that is easy to work with.

Suitable isocyanate-group-containing polymers are especially reaction products of polyols with diisocyanates, especially in a molar NCO/OH ratio of from 1.5/1 to 10/1, preferably from 3/1 to 7/1, it being optionally possible for unreacted monomeric diisocyanates to have been removed from the polymer.

A suitable diisocyanate is especially hexane 1,6-diisocyanate (HDI), 2,2(4),4-trimethylhexane 1,6-diisocyanate (TMDI), 1-methyl-2,4(6)-diisocyanatocyclohexane (H₆-TDI), isophorone diisocyanate (IPDI), 4,4′-diisocyanatodicyclohexylmethane (H₁₂-MDI), diphenylmethane 4(2),4′-diisocyanate (MDI) or toluene 2,4(6)-diisocyanate (TDI). Preference is given to HDI, IPDI, TDI or MDI. Particular preference is given to IPDI.

Suitable polyols are polyols having a hydrocarbon, polyether or polyester backbone, especially
polyether polyols, especially polyoxyalkylene diols or polyoxyalkylene triols, especially polymerization products of ethylene oxide or 1,2-propylene oxide or 1,2- or 2,3-butylene oxide or oxetane or tetrahydrofuran, or mixtures thereof, where these are polymerizable with the aid of a starter molecule having two or more active hydrogen atoms.
   Preferred polyether polyols are polyoxypropylene diols or polyoxypropylene triols, or ethylene oxide-terminated (EO-endcapped) polyoxypropylene diols or triols. The latter are polyoxyethylene-polyoxypropylene copolyols, which are obtained especially by further alkoxylating polyoxypropylene diols or triols with ethylene oxide at the end of the polypropoxylation reaction, the end product consequently having primary hydroxyl groups.
   Preferred polyether polyols have a degree of unsaturation of less than 0.02 meq/g, in particular less than 0.01 meq/g.
polyester polyols from the polycondensation of dicarboxylic acids with dihydric or trihydric alcohols, especially dimer-fatty-acid-based polyester polyols, such as those commercially available for example from Cargill.
polyhydroxy-functional fats or oils, especially natural fats or oils, such as in particular castor oil, derivatives of castor oil or polyols based on vegetable oil, such as those available under the Sovermol® trade name (from BASF).
polyether polyester polyols.
polyhydrocarbon polyols, such as in particular polybutadiene polyols.

Preference is given to polyols that are liquid at room temperature.

Preference is given to polyols having an OH value of from 9 to 115 mg KOH/g, preferably 14 to 60 mg KOH/g, in particular 18 to 40 mg KOH/g.

Particular preference is given to polyether polyols, dimer-fatty-acid-based polyester polyols or polyhydroxy-functional fats or oils. Greatest preference is given to polyether polyols, especially polyoxypropylene diols, polyoxypropylene triols, ethylene oxide-terminated polyoxypropylene diols or ethylene oxide-terminated polyoxypropylene triols.

The second component of the curable composition comprises at least one compound having two or more thiol groups.

Preferably, the compound having two or more thiol groups has 2 to 10, preferably 2 to 6, in particular 2 to 4, thiol groups.

Preferably, the compound having two or more thiol groups has a thiol equivalent weight of from 65 to 800 g/eq, preferably 65 to 400 g/eq, in particular 80 to 300 g/eq.

Preferably, the compound having two or more thiol groups has a molecular weight of from 130 to 1600 g/mol, in particular 130 to 1000 g/mol.

The compound having two or more thiol groups is preferably liquid at room temperature. In particular, it has a viscosity at 20° C. of 0.01 to 50 Pa·s, preferably 0.05 to 20 Pa·s, more preferably 0.05 to 10 Pa·s, in particular 0.5 to 5 Pa·s, measured using a cone-plate viscometer with cone diameter 50 mm, cone angle 1°, cone tip-plate distance 0.05 mm, and shear rate 10 s⁻¹, and with cone diameter 10 mm for viscosities of more than 1 Pa·s. Such compounds are easy to work with at ambient temperatures even without addition of solvents or thinners.

Suitable as a compound having two or more thiol groups is a polymercaptan such as in particular 1,8-dimercaptooctane, 1,10-dimercaptodecane, 1,5-dimercapto-3-oxapentane, 1,8-dimercapto-3,6-dioxaoctane (DMDO), 1,5-dimercapto-3-thiapentane, 1,9-dimercapto-3,7-dithianonane, 1,2-dimercaptomethyl-4,5-dimethylbenzene, 1,3-dimercaptobenzene, 1,4-dimercaptobenzene, 1,3,5-trimercaptobenzene, 1,5-dimercaptonaphthalene, bis(4-mercaptophenyl)thiamethane, 1,2-ethanediol di(2-mercaptoacetate), butane-1,4-diol di(2-mercaptoacetate), 1,1,1-trimethylolpropane tris(2-mercaptoacetate), pentaerythritol tetrakis(2-mercaptoacetate), ethane-1,2-diol di(3-mercaptopropionate) (GDMP), butane-1,4-diol di(3-mercaptopropionate), 1,1,1-trimethylolpropane tris(3-mercaptopropionate) (TMPMP), pentaerythritol tetrakis(3-mercaptopropionate) (PETMP), 3-mercapto-2-hydroxypropyl ether of propoxylated pentaerythritol, tris(2-(3-mercaptopropionyloxy)ethyl) isocyanurate or mercapto-group-containing polysulfide polymers.

The compound having two or more thiol groups is preferably selected from the group consisting of 1,8-dimercapto-3,6-dioxaoctane, ethane-1,2-diol di(2-mercaptoacetate), butane-1,4-diol di(2-mercaptoacetate), 1,1,1-trimethylolpropane tris(2-mercaptoacetate), pentaerythritol tetrakis(2-mercaptoacetate), ethane-1,2-diol di(3-mercaptopropionate), butane-1,4-diol di(3-mercaptopropionate), 1,1,1-trimethylolpropane tris(3-mercaptopropionate), pentaerythritol tetrakis(3-mercaptopropionate), 3-mercapto-2-hydroxypropyl ether of propoxylated pentaerythritol having an average thiol-equivalent weight of 180 to 400 g/eq, tris(2-(3-mercaptopropionyloxy)ethyl) isocyanurate, and mercapto-group-containing polysulfide polymers having an average thiol equivalent weight of 250 to 800 g/eq.

Preference among these is given to compounds having a thiol equivalent weight of 80 to 300 g/eq.

A commercial 3-mercapto-2-hydroxypropyl ether of propoxylated pentaerythritol is for example Capcure® 3-800 (from Huntsman).

Mercapto-group-containing polysulfide polymers are commercially available for example under the Thiokol® trade name from Toray Fine Chemicals.

Preference is given to a combination of an aldehyde-group-containing polymer having an average molecular weight Mₙ of at least 1000 g/mol, preferably at least 2000 g/mol, and a polymercaptan having a thiol equivalent weight of 80 to 300 g/eq. Such a curable composition permits high extensibility coupled with high strength.

In the curable composition, the ratio of the number of thiol groups to the number of aldehyde groups is in the range from 1.5 to 4, preferably 1.7 to 3, in particular 1.8 to 2.5. This permits rapid and problem-free curing to an elastic, non-tacky polymer.

In a preferred aspect of the invention, the curable composition comprises at least one filler selected from aluminum oxide, aluminum hydroxide, zinc oxide, and zinc hydroxide. Such compositions show reliable and rapid curing and, once they have been cured, particularly high mechanical strength and extensibility and surprisingly good stability to heat and moisture, particularly by comparison with other customary fillers such as kaolin, quartz flour or calcium carbonate (chalk).

Preference is given to aluminum oxide or aluminum hydroxide, especially aluminum hydroxide. Aluminum hydroxide is also termed aluminum trihydrate (ATH). It additionally increases thermal conductivity and acts as a flame retardant, making such a composition suitable also for uses with increased requirements as regards thermal conductivity or flame retardancy.

Preferably, the curable composition contains, based on the total composition, a content of aluminum oxide, aluminum hydroxide, zinc oxide and/or zinc hydroxide of 10 to 90% by weight, preferably 20 to 80% by weight, in particular 25 to 70% by weight.

Preferably, the composition comprises as catalyst at least one inorganic or organic acid or a compound hydrolyzable to an acid, especially an organic carboxylic acid such as in particular acetic acid, benzoic acid, salicylic acid, 2-nitrobenzoic acid or lactic acid, or an organic sulfonic acid such as in particular methanesulfonic acid, p-toluenesulfonic acid or p-dodecylbenzenesulfonic acid, or a sulfonic ester, phosphoric acid or a phosphoric ester, or phosphonic acid or a phosphonic ester. Such a composition cures rapidly and without problems and permits cured compositions with good resistance to heat and moisture.

The curable composition may additionally comprise further constituents, especially:
adhesion promoters, especially titanates or organoalkoxysilanes such as in particular mercaptosilanes, epoxysilanes, vinylsilanes, (meth)acrylosilanes, carbamatosilanes, alkylsilanes, S-(alkylcarbonyl)mercaptosilanes or oligomeric forms of these silanes;
further fillers, especially ground or precipitated calcium carbonates, optionally coated with fatty acids, especially stearates, barytes, quartz flours, quartz sands, dolomites, wollastonites, kaolins, calcined kaolins, sheet silicates, such as mica or talc, zeolites, magnesium hydroxides, silicas, including finely divided silicas from pyrolysis processes, industrially produced carbon blacks, graphite, ground fillers from agricultural sources such as in particular olive kernel flour or nut kernel flour, metal powders, for example of aluminum, copper, iron, silver or steel, PVC powders or hollow beads;
pigments, especially titanium dioxide, chromium oxide, iron oxides or organic pigments;
plasticizers, especially phthalates, especially diisononyl phthalate (DINP), diisodecyl phthalate (DIDP) or di(2-propylheptyl) phthalate (DPHP), hydrogenated phthalates, especially diisononyl cyclohexane-1,2-dicarboxylate (DINCH), terephthalates, especially bis(2-ethylhexyl) terephthalate or diisononyl terephthalate (DINT), hydrogenated terephthalates, especially bis(2-ethylhexyl) cyclohexane-1,4-dicarboxylate or diisononyl cyclohexane-1,4-dicarboxylate, isophthalates, trimellitates, adipates, especially dioctyl adipate (DOA), azelates, sebacates, benzoates, glycol ethers, glycol esters, plasticizers having polyether structure, especially polypropylene oxide monools, diols or triols, or polypropylene oxide monools, diols or triols having blocked hydroxyl groups, especially in the form of acetate groups, and organic sulfonates or phosphates, especially diphenyl cresyl phosphate (DPK), polybutenes, polyisobutenes or plasticizers derived from natural fats or oils, especially epoxidized soybean oil or linseed oil, especially phthalates, hydrogenated phthalates, adipates or plasticizers having polyether structure;
fibers, especially glass fibers, carbon fibers, metal fibers, ceramic fibers, hemp fibers, cellulose fibers or plastics fibers such as polyamide fibers or polyethylene fibers;
nanofillers such as graphene or carbon nanotubes;
dyes;
solvents;
modifiers such as hydrocarbon resins, natural or synthetic waxes or bitumen;
rheology modifiers, especially urea compounds, sheet silicates such as bentonites, derivatives of castor oil, hydrogenated castor oil, polyamides, polyurethanes, fumed silicas or hydrophobically modified polyoxyethylenes;
desiccants, especially molecular sieves, calcium oxide, monooxazolidines such as Incozol® 2 (from Incorez) or orthoformic esters;
nonreactive thermoplastic polymers, such as homo- or copolymers of unsaturated monomers, especially from the group comprising ethylene, propylene, butylene, isobutylene, isoprene, vinyl acetate and alkyl (meth)acrylates, especially polyethylenes (PE), polypropylenes (PP), polyisobutylenes, ethylene-vinyl acetate copolymers (EVA) and atactic poly-α-olefins (APAO);
flame-retardant substances, especially the aluminum hydroxide or magnesium hydroxide fillers already mentioned, organic phosphoric esters, ammonium polyphosphates, melamine or derivatives thereof, boron compounds or antimony compounds;
additives, especially wetting agents, leveling agents, defoamers, deaerators, stabilizers against oxidation, heat, light or UV radiation, or biocides;
and other substances customarily used in curable compositions.

Such additions may be present as constituents of the first or of the second component. Substances reactive to mercapto groups are preferably a constituent of the first component; substances reactive to aldehyde groups are preferably a constituent of the second component.

The composition preferably comprises as adhesion promoter at least one mercaptosilane, such as in particular 3-mercaptopropyltrimethoxysilane or 3-mercaptopropyltriethoxysilane. The mercaptosilane is preferably a constituent of the second component. This permits compositions having particularly good adhesion properties.

The composition preferably comprises at least one plasticizer selected in particular from DINP, DIDP, DPHP, DINCH, bis(2-ethylhexyl) terephthalate, DINT, bis(2-ethylhexyl) cyclohexane-1,4-dicarboxylate, diisononyl cyclohexane-1,4-dicarboxylate, DOA, polypropylene oxide monools, polypropylene oxide diols, polypropylene oxide triols, polypropylene oxide monool acetates, polypropylene oxide diol diacetates, polypropylene oxide triol triacetates, and DPK.

The composition preferably comprises, based on the total composition, 5% to 80% by weight, preferably 10% to 60% by weight, in particular 10% to 40% by weight, of plasticizers.

In a preferred embodiment of the invention, the curable composition comprises fillers and plasticizers, in particular it comprises, based on the total composition, 20% to 90% by weight, in particular 30% to 80% by weight, of fillers and 5% to 60% by weight of plasticizers.

The curable composition preferably comprises, based on the total composition,
5% to 99% by weight, preferably 5% to 90% by weight, in particular 10% to 70% by weight, of the aggregate of the aldehyde-group-containing polymers and compounds having two or more thiol groups,
0% to 60% by weight, preferably 10% to 60% by weight, 10% to 40% by weight, of plasticizers,
0% to 90% by weight, preferably 20% to 90% by weight, in particular 30% to 80% by weight, of fillers,
and optionally further substances.

In a preferred embodiment, the curable composition comprises at least one ground filler from an agricultural source, especially a lignin-containing granulate such as in particular an olive kernel flour. This permits cured compositions having very high mechanical strength coupled with surprisingly good stability to heat and moisture.

The curable composition preferably contains less than 10% by weight, more preferably less than 5% by weight, in particular less than 1% by weight, of volatile organic solvents having a boiling point at standard pressure of less than 250° C., based on the total composition. Such a composition gives rise to a particularly low level of emissions.

The curable composition is preferably not water-based. It is preferably largely free of water or contains only a low content of water, in particular less than 10% by weight, preferably less than 5% by weight, in particular less than 2% by weight, of water based on the total composition. Such a composition cures rapidly irrespective of ambient humidity, can be used in thick layers and/or between water-impermeable substrates, and shows barely any shrinkage on curing.

The curable composition preferably contains less than 10% by weight, more preferably less than 5% by weight, in particular less than 1% by weight, of silicone compounds. Such a composition is easily paintable and shows particularly good adhesion properties.

The consistency of the first and second components of the curable composition is suitably such that the components can be readily mixed with one another by simple methods under ambient conditions. Liquid or pasty components are particularly suitable for this purpose.

The first and second components of the curable composition are produced separately from one another. The constituents of the respective component are in this case mixed with one another so as to give a macroscopically homogeneous mass. Each component is stored in a separate container. Suitable containers are especially a drum, a container, a hobbock, a bucket, a canister, a can, a bag, a tubular bag, a cartridge or a tube. The components are storage-stable.

For use of the curable composition, the two components and any further components present are mixed with one another shortly before or during the application.

The chosen mixing ratio here is such that the ratio of the number of thiol groups to the number of aldehyde groups is within the preferred range. In parts by weight, the mixing ratio between the first and second components is typically in the range from about 100:1 to 1:10, preferably 50:1 to 1:5, in particular 10:1 to 1:2.

If the components are mixed with one another prior to application, it must be ensured that not too much time passes between the mixing of the components and the application, since the onset of reaction and the associated rise in viscosity can otherwise lead to problems, for example inadequate leveling or retarded or incomplete adhesion to the substrate. More particularly, the open time of the composition should not be exceeded during application.

“Open time” refers here to the period of time between the mixing of the components and the end of a state of the composition suitable for processing.

Mixing preferably takes place at ambient temperature, in particular at a temperature in the range from −5 to 50° C., in particular 0 to 40° C.

On mixing the two components, the composition starts to cure through the onset of chemical reaction. The aldehyde groups react with the thiol groups, with the formation mainly of thioacetal groups. These crosslinking reactions result in the composition curing to a non-tacky elastic polymer.

Curing preferably takes place at ambient temperature, in particular at a temperature in the range from −5 to 50° C., in particular 0 to 40° C.

The invention further provides the cured composition obtained from the curable composition after the two components have been mixed.

The cured composition is preferably elastic and has high strength coupled with high extensibility.

The cured composition preferably has a tensile strength, determined according to DIN EN 53504 as described in the examples, of at least 1 MPa, preferably at least 1.5 MPa.

The cured composition preferably has an elongation at break, determined according to DIN EN 53504 as described in the examples, of at least 50%, more preferably at least 100%, in particular at least 150%.

The cured composition preferably has a Shore A hardness, determined according to DIN 53505 as described in the examples, in the range from 10 to 90, more preferably 20 to 85, in particular 30 to 80.

In addition, the cured composition has good resistance to heat and water. The cured composition preferably shows high strength coupled with high extensibility and the Shore A hardness remaining within the preferred range, even after storage for 7 days at 100° C. or at 70° C. and 100% relative humidity.

In addition, the cured composition has good adhesion properties on customary substrates such as in particular glass, aluminum, concrete or wood.

The curable composition is suitable for a multitude of uses. It can especially be used as adhesive, sealant, coating, casting resin or spackling compound.

The invention further provides for the use of the curable composition as elastic adhesive, elastic sealant or elastic coating, where the first and second and any further components present are mixed with one another and the mixed composition is applied in the liquid state to at least one substrate.

Suitable substrates are especially:
glass, glass ceramic, concrete, mortar, cement screed, fiber cement, brick, tile, plaster or natural stones such as granite or marble;
repair or leveling compounds based on PCC (polymer-modified cement mortar) or ECC (epoxy-resin-modified cement mortar);
metals or alloys such as aluminum, iron, steel, copper, other nonferrous metals, including surface-finished metals or alloys such as galvanized or chrome-plated metals;
asphalt or bitumen;
leather, textiles, paper, wood, wood-based materials bonded with resins, for example phenolic, melamine or epoxy resins, resin-textile composites or further so-called polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFRP), glass fiber-reinforced plastics (GFRP), natural fiber-reinforced plastics (NFRP) and sheet molding compounds (SMC);
insulation foams, especially made of EPS, XPS, PUR, PIR, rock wool, glass wool, aerogel or foamed glass;
coated or painted substrates, especially painted tiles, coated concrete, powder-coated metals or alloys or painted metal sheets;
coatings, paints or varnishes.

The substrates can if required be pretreated prior to application, especially by physical and/or chemical cleaning methods or the application of an activator or a primer.

It is possible to bond and/or seal two substrates of the same or different types.

The use of the curable composition affords an article. The article has especially been bonded, sealed or coated with the composition. This article may be a built structure or part thereof, especially a civil engineering structure built above or below ground, a bridge, a roof, a staircase or a facade, or it may be an industrial good or a consumer good, especially a window, a pipe, a rotor blade of a wind turbine, a domestic appliance or a mode of transport such as in particular an automobile, a bus, a truck, a rail vehicle, a ship, an aircraft or a helicopter, or an installable component thereof.

### EXAMPLES

Specified hereinbelow are working examples that are intended to more particularly elucidate the described invention. The invention is of course not limited to these described working examples.

“Standard climatic conditions” (“SCC”) refers to a temperature of 23±1° C. and a relative humidity of 50±5%.

The chemicals used were from Sigma-Aldrich Chemie GmbH, unless otherwise stated.

### DESCRIPTION OF THE MEASUREMENT METHODS

Viscosity was measured on a thermostated Rheotec RC30 cone-plate viscometer (cone diameter 50 mm, cone angle 1°, cone tip-plate distance 0.05 mm, shear rate 10 s⁻¹). Viscosities of less than 100 mPa·s were measured with a shear rate of 100 s⁻¹. Viscosities of more than 500 Pa·s were measured with a shear rate of 2 s⁻¹.

Infrared spectra (FTIR) were measured as undiluted films on a Nicolet iS5 FTIR instrument from Thermo Scientific equipped with a horizontal ATR measurement unit with a diamond crystal. Absorption bands are reported in wavenumbers (cm⁻¹).

### Production of Isocyanate-Group-Containing Polymers:

### Polymer P-1:

780 g of ethylene oxide-terminated polyoxypropylene triol (Desmophen® 5031 BT, OH value 28.0 mg KOH/g, OH functionality approx. 2.3, from Covestro) and 303 g of isophorone diisocyanate (Vestanat® IPDI, from Evonik) were reacted at 80° C. by a known method to afford a reaction mixture having an NCO content of 9.1% by weight. The volatile constituents, in particular unreacted isophorone diisocyanate, were then removed by distillation in a short-path evaporator (jacket temperature 160° C., pressure 0.1 to 0.005 mbar) to afford a polymer having an NCO content of 1.84% by weight, a viscosity of 8.2 Pa·s at 20° C., and a content of monomeric isophorone diisocyanate of 0.02% by weight.

### Polymer P-2:

818 g of polyoxypropylene diol (Acclaim® 4200, OH value 28.5 mg KOH/g, from Covestro) and 227 g of isophorone diisocyanate (Vestanat® IPDI, from Evonik) were reacted at 80° C. by a known method to afford a reaction mixture having an NCO content of 6.6% by weight. The volatile constituents, in particular unreacted isophorone diisocyanate, were then removed by distillation in a short-path evaporator (jacket temperature 160° C., pressure 0.1 to 0.005 mbar) to afford a polymer having an NCO content of 1.91% by weight, a viscosity of 6.5 Pa·s at 20° C., and a content of monomeric isophorone diisocyanate of 0.03% by weight.

### Polymer P-3:

725 g of ethylene oxide-terminated polyoxypropylene triol (Desmophen® 5031 BT, OH value 28.0 mg KOH/g, OH functionality approx. 2.3, from Covestro) and 275 g of diphenylmethane 4,4′-diisocyanate (Desmodur® 44 MC L, from Covestro) were reacted at 80° C. by a known method to afford a reaction mixture having an NCO content of 7.6% by weight. The volatile constituents, in particular unreacted diphenylmethane 4,4′-diisocyanate, were then removed by distillation in a short-path evaporator (jacket temperature 180° C., pressure 0.1 to 0.005 mbar, condensation temperature 47° C.) to afford a polymer having an NCO content of 1.68% by weight, a viscosity of 19 Pa·s at 20° C., and a content of monomeric diphenylmethane 4,4′-diisocyanate of 0.04% by weight.

### Polymer P-4:

727.0 g of polyoxypropylene diol (Acclaim® 4200, OH value 28 mg KOH/g, from Covestro) and 273.0 g of diphenylmethane 4,4′-diisocyanate (Desmodur® 44 MC L, from Covestro) were reacted at 80° C. by a known method to afford a reaction mixture having an NCO content of 7.6% by weight. The volatile constituents, in particular unreacted diphenylmethane 4,4′-diisocyanate, were then removed by distillation in a short-path evaporator (jacket temperature 180° C., pressure 0.1 to 0.005 mbar, condensation temperature 47° C.) to afford a polymer having an NCO content of 1.7% by weight, a viscosity of 15.2 Pa·s at 20° C., and a content of monomeric diphenylmethane 4,4′-diisocyanate of 0.08% by weight.

### Polymer P-5:

600 g of polyoxypropylene diol (Voranol® 1010 L, OH value 112 mg KOH/g, from Dow) and 533.3 g of isophorone diisocyanate (Vestanat® IPDI, from Evonik) were reacted at 80° C. by a known method to afford a reaction mixture having an NCO content of 15.6% by weight. The volatile constituents, in particular unreacted isophorone diisocyanate, were then removed by distillation in a short-path evaporator (jacket temperature 160° C., pressure 0.1 to 0.005 mbar) to afford a polymer having an NCO content of 5.18% by weight, a viscosity of 21.8 Pa·s at 20° C., and a content of monomeric isophorone diisocyanate of 0.03% by weight.

### Production of Aldehyde-Group-Containing Polymers:

### Polymers A-1 to A-6:

The amounts specified in Table 1 of the specified isocyanate-group-containing polymer were reacted in the presence of 0.02% by weight of dibutyltin dilaurate, with exclusion of moisture at 110° C., with the specified amounts of the corresponding hydroxyaldehyde until isocyanate groups were no longer detectable by IR spectroscopy. In the case of the polymers having aromatic isocyanate groups P-3 and P-4, the reaction was carried out without dibutyltin dilaurate and at 80° C.

The properties of polymers A-1 to A-6 are reported in Table 1.

The average molecular weight Mₙ of polymer A-1 was determined by gel-permeation chromatography (GPC) against polystyrene (474 to 2 520 000 g/mol) as standard with tetrahydrofuran as mobile phase and refractive index detector.

The average molecular weight Mₙ was 6100 g/mol.

TABLE 1
Production and properties of polymers A-1 to A-6, amounts in parts by weight.

| Polymer | A-1 | A-2 | A-3 | A-4 | A-5 | A-6 |
|---|---|---|---|---|---|---|
| Polymer P-1 | 500.0 | — | — | — | 500.0 | 500.0 |
| Polymer P-2 | — | 500.0 | — | — | — | — |
| Polymer P-3 | — | — | 500.0 | — | — | — |
| Polymer P-4 | — | — | — | 500.0 | — | — |
| 5-Hydroxymethylfurfural | 27.7 | 28.9 | 25.5 | 25.5 | — | — |
| 2-(2- | — | — | — | — | 37.4 | — |
| Hydroxyethoxy)benzaldehyde | | | | | | |
| Vanillin dialdehyde ¹ | — | — | — | — | — | 78.9 |
| Viscosity (20° C.) [Pa · s] | 63.7 | 33.2 | 187.1 | 146.4 | 138.3 | 1050 |
| Aldehyde equivalent | 2400 | 2310 | 2600 | 2600 | 2451 | 1322 |
| weight [g/eq] | | | | | | |

¹ 4,4′-(2-Hydroxypropane-1,3-diyl)bis(oxy)bis(3-methoxybenzaldehyde), prepared from 2 mol of vanillin and 1 mol of epichlorohydrin

Employed Compounds with Thiol Groups:
GDMP Ethylene glycol di(3-mercaptopropionate), 123.5 g/eq SH (Thiocure® GDMP, from Bruno Bock GmbH)
TMPMP 1,1,1-Trimethylolpropane tris(3-mercaptopropionate), 138 g/eq SH (Thiocure® TMPMP, from Bruno Bock GmbH)
PETMP Pentaerythritol tetrakis(3-mercaptopropionate), 127 g/eq SH (Thiocure® PETMP, from Bruno Bock GmbH)
DMDO 1,8-Dimercapto-3,6-dioxaoctane, 91 g/eq SH
Capcure® 3-800 3-Mercapto-2-hydroxypropyl ether of propoxylated pentaerythritol, approx. 267 g/eq SH (from Huntsman)
Thiokol® LP-33 Linear polysulfide polymer with mercapto end groups, 574 g/eq SH (from Toray Fine Chemicals)
Thiokol® LP-2 Linear polysulfide polymer with mercapto end groups, 1886 g/eq SH (from Toray Fine Chemicals)
Polymer SH-1 Mercapto-group-containing polymer from the reaction of polymer P-1 and 2-thioethanol, approx. 2307 g/eq SH, produced as described below
Mercaptosilane 3-Mercaptopropyltrimethoxysilane

### Polymer SH-1:

250.0 g of polymer P-1 having an NCO content of 1.84% by weight and produced as described above was reacted in the presence of 1.0 g of dibutyltin dilaurate, with exclusion of moisture at 80° C., with 8.8 g of 2-mercaptoethanol until isocyanate groups were no longer detectable by IR spectroscopy. The polymer obtained had a theoretical mercapto equivalent weight of 2307 g/eq.

### Production of Curable Compositions:

### Examples Z-1 to Z-21

For each example, the ingredients of the first component (K1) that are specified in Tables 2 to 6 were mixed in the specified amounts (in parts by weight) using a centrifugal mixer (SpeedMixer™ DAC 150, FlackTek Inc.) and stored in a closed container.

The ingredients of the second component (K2) that are specified in Tables 2 to 5 were likewise processed and stored.

The “ATH” used was aluminum hydroxide (Martinal® OL-104, from Martinswerk).

The “carbon black” used was Monarch® 570 (from Cabot).

The “kaolin calcined” used was Satintone® W (from BASF).

The “quartz flour” used was one having a grain size of 0 to 75 μm.

The “chalk” used was Omyacarb® 5 GU (from Omya).

The “olive seed flour” used was dried, ground olive kernel shells from the extraction of olive oil having a particle size <100 μm (from Micronizados Vegetales S.L).

The two components of each composition were then processed into a homogeneous liquid using the centrifugal mixer and said liquid was immediately tested as follows:

Gel time was determined by moving a freshly mixed amount of approx. 3 g under standard climatic conditions with a spatula at regular intervals until the mass underwent gelation.

Mechanical properties were determined by applying the mixed composition to a silicone-coated release paper to give a film of thickness 2 mm, storing the film under standard climatic conditions for 7 days, punching a few dumbbell-shaped test specimens having a length of 75 mm with a bar length of 30 mm and a bar width of 4 mm out of the film, and testing these in accordance with DIN EN 53504 at a strain rate of 200 mm/min in respect of tensile strength, elongation at break, and elastic modulus EM 5% (at 0.5%-5% elongation) and EM 50% (at 0.5%-50% elongation). In addition, a number of test specimens were punched out for determination of tear propagation resistance and were tested in accordance with DIN ISO 34-1, Method B (angular test specimens) at a strain rate of 500 mm/min.

These results are given the additional identifier “7d SCC”.

To determine the stability to heat and hydrolysis, after curing under standard climatic conditions for 7 days, further dumbbell-shaped test specimens were in some examples additionally stored for 7 days at 70° C. and 100% relative humidity followed by 24 hours under standard climatic conditions and the tensile strength, elongation at break, and elastic modulus EM 5% and EM 50% thereof determined. These results are given the additional identifier “+7d 70/100”.

Shore A hardness was determined according to DIN 53505 on test specimens cured under standard climatic conditions for 7 days. These results are given the additional identifier “7d SCC”. To determine the stability to heat and hydrolysis, after curing under standard climatic conditions for 7 days further Shore A test specimens were either additionally stored for 7 days at 70° C. and 100% relative humidity or additionally stored for 7 days in an air-circulation oven at 100° C. and, after being cooled to room temperature, the Shore A hardness was in each case determined as described. These results are respectively given the additional identifier “+7 d 70/100” and “+7 d 100° C.”.

As a measure of the strength of an adhesive bond, the lap shear strength on glass of some compositions was determined. For this purpose, composite specimens were produced by bonding two glass plates that had been degreased with isopropanol and pretreated with Sika® Aktivator-205 (from Sika Schweiz) in such a way that the overlapping adhesive bond had dimensions of 12×25 mm and a thickness of 4 mm and the glass plates protruded at the top ends. After the composite specimens had been stored under standard climatic conditions for 7 days, the lap shear strength was tested according to DIN EN 1465 at a strain rate of 20 mm/min. The fracture profile was then assessed in respect of AF (adhesive failure) or CF (cohesive failure). In the absence of further information, the fracture profile reported in the table was assessed in respect of 90% to 100% of the fracture area.

The results are given in Tables 2 to 6.

The examples labeled “(Ref.)” are noninventive comparative examples.

The curing of the inventive examples for 7 days under standard climatic conditions resulted in all cases in the formation of a non-tacky, elastic material.

TABLE 2
Composition and properties of Z-1 to Z-6.

| Example | Z-1 | Z-2 | Z-3 | Z-4 | Z-5 | Z-6 |
|---|---|---|---|---|---|---|
| Component K1: | | | | | | |
| Polymer A-1 | 30.0 | 30.0 | 30.0 | 30.0 | 27.0 | 30.0 |
| Diisodecyl phthalate | 20.0 | 20.0 | 20.0 | 20.0 | 20.8 | 20.0 |
| ATH | 30.0 | 30.0 | 30.0 | 30.0 | 30.2 | 30.0 |
| Carbon black | 10.0 | 10.0 | 10.0 | 10.0 | 10.5 | 10.0 |
| Component K2: | | | | | | |
| GDMP | 2.8 | — | — | — | — | — |
| TMPMP | — | 3.9 | — | — | — | — |
| PETMP | — | — | 3.6 | — | — | — |
| DMDO | — | — | — | 2.3 | — | — |
| Capcure ® 3-800 | — | — | — | — | 5.4 | — |
| Thiokol ® LP-33 | — | — | — | — | — | 13.4 |
| Mercaptosilane | 0.6 | 0.9 | 0.9 | 0.9 | 0.6 | 1.0 |
| pDBSA ¹ | 0.25 | 0.25 | 0.25 | 0.3 | 0.2 | 0.3 |
| Gel time [min] | 90 | 25 | 20 | 8 | 25 | 18 |
| 7 d SCC: | | | | | | |
| Tensile strength | 1.5 | 2.0 | 2.2 | 1.5 | 1.8 | 1.0 |
| [MPa] | | | | | | |
| Elongation at | 195 | 100 | 90 | 175 | 130 | 115 |
| break [%] | | | | | | |
| EM 5% [MPa] | 1.7 | 4.3 | 4.9 | 2.0 | 2.6 | 1.7 |
| EM 50% [MPa] | 1.1 | 1.6 | 1.6 | 1.2 | 1.5 | 1.1 |
| Tear propagation | 3.1 | 3.2 | 3.1 | 3.2 | 3.1 | 2.2 |
| resistance [N/mm] | | | | | | |
| +7 d 70/100: | | | | | | |
| Tensile strength | 1.7 | 2.2 | 2.3 | 1.3 | 2.2 | 0.9 |
| [MPa] | | | | | | |
| Elongation at | 150 | 77 | 78 | 180 | 110 | 100 |
| break [%] | | | | | | |
| EM 5% [MPa] | 1.7 | 3.6 | 4.5 | 1.5 | 2.8 | 1.0 |
| EM 50% [MPa] | 1.7 | 3.3 | 3.1 | 1.3 | 2.6 | 0.9 |
| Shore A (7 d SCC) | 48 | 61 | 65 | 45 | 53 | 44 |
| (+7 d 70/100) | 44 | 60 | 63 | 48 | 55 | 43 |
| (+7 d 100° C.) | 54 | 64 | 65 | 54 | 60 | 48 |
| Lap shear strength | 1.2 | 1.1 | 0.9 | 1.2 | 1.1 | 0.6 |
| (glass) [MPa] | | | | | | |
| Fracture profile | CF | CF | CF | CF | CF | AF |

¹ p-Dodecylbenzenesulfonic acid

TABLE 3
Composition and properties of Z-7 to Z-11.

| Example | Z-7 | Z-8 | Z-9 | Z-10 | Z-11 |
|---|---|---|---|---|---|
| Component K1: | | | | | |
| Polymer | A-2 | A-3 | A-4 | A-5 | A-6 |
| | 30.0 | 30.0 | 30.0 | 30.0 | 30.0 |
| Diisodecyl phthalate | 20.0 | 20.0 | 20.0 | 20.0 | 20.0 |
| ATH | 30.0 | 30.0 | 30.0 | 30.0 | 30.0 |
| Carbon black | 10.0 | 10.0 | 10.0 | 10.0 | 10.0 |
| Component K2: | | | | | |
| DMDO | 2.35 | 2.07 | 2.10 | 2.02 | 4.13 |
| Mercaptosilane | 0.9 | 0.9 | 0.9 | 0.43 | 0.9 |
| pDBSA ¹ | 0.22 | 0.22 | 0.20 | 0.36 | 0.30 |
| Gel time [min] | 30 | 8 | 65 | 60 | 20 |
| 7 d SCC: | | | | | |
| Tensile strength [MPa] | 1.4 | 2.8 | 2.1 | 1.3 | 3.4 |
| Elongation at break | 190 | 255 | 380 | 235 | 145 |
| [%] | | | | | |
| EM 5% [MPa] | 1.6 | 2.3 | 0.9 | 0.8 | 4.5 |
| EM 50% [MPa] | 1.1 | 0.9 | 0.8 | 0.9 | 1.7 |
| Tear propagation | 2.7 | 3.5 | 5.8 | n.d. | 3.1 |
| resistance [N/mm] | | | | | |
| Shore A (7 d SCC) | 43 | 48 | 33 | 35 | 48 |
| (+7 d 70/100) | 44 | 40 | 27 | n.d. | n.d. |
| (+7 d 100° C.) | 48 | n.d. | n.d. | n.d. | n.d. |
| Lap shear strength | 1.2 | 1.3 | 1.6 | 1.2 | 1.5 |
| (glass) [MPa] | | | | | |
| Fracture profile | CF | CF | CF | CF | AF/CF |
| | | | | | 50/50 |

¹ p-Dodecylbenzenesulfonic acid
“n.d.” stands for “not determined”

TABLE 4
Composition and properties of Z-1 and Z-12 to Z-15.

| Example | Z-1 | Z-12 | Z-13 | Z-14 | Z-14a | Z-15 |
|---|---|---|---|---|---|---|
| Component K1: | | | | | | |
| Polymer A-1 | 30.0 | 30.0 | 30.0 | 30.0 | 30.0 | 30.0 |
| Diisodecyl phthalate | 20.0 | 20.0 | 20.0 | 20.0 | 20.0 | — |
| ATH | 30.0 | — | — | — | — | — |
| Kaolin calcined | — | 30.0 | — | — | — | — |
| Quartz flour | — | — | 30.0 | — | — | — |
| Chalk | — | — | — | 30.0 | — | — |
| Olive seed flour | — | — | — | — | 15.0 | — |
| Carbon black | 10.0 | 10.0 | 10.0 | 10.0 | 10 | — |
| Component K2: | | | | | | |
| GDMP | 2.8 | 2.8 | 2.8 | 2.8 | 2.9 | 2.8 |
| Mercaptosilane | 0.6 | 0.5 | 0.5 | 0.5 | 0.4 | 0.5 |
| pDBSA ¹ | 0.25 | 0.2 | 0.2 | 0.4 | 0.15 | 0.1 |
| Gel time [min] | 90 | 20 | 6 | 6 | 20 | n.d. |
| 7 d SCC: | | | | | | |
| Tensile strength | 1.5 | 3.7 | 1.54 | 1.1 | 1.8 | 0.9 |
| [MPa] | | | | | | |
| Elongation at | 195 | 90 | 67 | 304 | 82 | 50 |
| break [%] | | | | | | |
| EM 5% [MPa] | 1.7 | 3.4 | 2.4 | 0.5 | 2.5 | 1.9 |
| EM 50% [MPa] | 1.1 | 3.7 | 2.5 | 0.5 | 2.4 | 1.5 |
| Tear propagation | 3.1 | 3.3 | 3.1 | 3.0 | 3.3 | 1.4 |
| resistance [N/mm] | | | | | | |
| +7 d 70/100: | | | | | | |
| Tensile strength | 1.7 | 0.9 | 0.7 | 1.3 | 1.6 | 0.9 |
| [MPa] | | | | | | |
| Elongation at | 150 | 137 | 113 | 160 | 93 | 55 |
| break [%] | | | | | | |
| EM 5% [MPa] | 1.7 | 0.73 | 0.43 | 1.12 | 1.7 | 1.7 |
| EM 50% [MPa] | 1.7 | 0.66 | 0.74 | 1.07 | 1.8 | 1.4 |
| Shore A (7 d SCC) | 48 | 61 | 52 | 17 | 53 | 55 |
| (+7 d 70/100) | 44 | 42 | 37 | 31 | 50 | 39 |
| (+7 d 100° C.) | 54 | 64 | 56 | 54 | 56 | 42 |
| Lap shear strength | 1.2 | 1.8 | 1.1 | 0.7 | 1.1 | n.d. |
| (glass) [MPa] | | | | | | |
| Fracture profile | CF | CF | CF | CF | CF | |

¹ p-Dodecylbenzenesulfonic acid
“n.d.” stands for “not determined”

TABLE 5
Composition and properties of Z-4 and Z-16 to Z-18.

| Example | Z-4 | Z-16 | Z-17 | Z-18 |
|---|---|---|---|---|
| Component K1: | | | | |
| Polymer A-1 | 30.0 | 30.0 | 30.0 | 30.0 |
| Diisodecyl phthalate | 20.0 | 20.0 | 20.0 | — |
| ATH | 30.0 | — | — | — |
| Kaolin calcined | — | 30.0 | — | — |
| Quartz flour | — | — | 30.0 | — |
| Carbon black | 10.0 | 10.0 | 10.0 | — |
| Component K2: | | | | |
| DMDO | 2.3 | 2.3 | 2.3 | 2.3 |
| Mercaptosilane | 0.9 | 0.9 | 0.9 | 0.9 |
| pDBSA ¹ | 0.3 | 0.15 | 0.2 | 0.15 |
| Gel time [min] | 8 | 10 | 13 | 10 |
| 7 d SCC: | | | | |
| Tensile strength [MPa] | 1.5 | 1.9 | 1.4 | 0.9 |
| Elongation at break [%] | 175 | 90 | 175 | 60 |
| EM 5% [MPa] | 2.0 | 2.4 | 1.8 | 1.5 |
| EM 50% [MPa] | 1.2 | 3.1 | 1.0 | 1.3 |
| Tear propagation resistance | 3.2 | 3.0 | n.d. | 1.2 |
| [N/mm] | | | | |
| +7 d 70/100: | | | | |
| Tensile strength [MPa] | 1.3 | 0.9 ² | 1.0 ² | 0.9 |
| Elongation at break [%] | 180 | 105 | 190 | 60 |
| EM 5% [MPa] | 1.5 | 0.8 | 0.5 | 1.6 |
| EM 50% [MPa] | 1.3 | 1.0 | 0.4 | 1.3 |
| Shore A (7 d SCC) | 45 | 55 | 47 | 45 |
| (+7 d 70/100) | 48 | 38 | 24 | 42 |
| (+7 d 100° C.) | 54 | 60 | n.d. | 45 |

¹ p-Dodecylbenzenesulfonic acid
² Tacky surface

TABLE 6
Composition and properties of Z-19 to Z-21.

| | Z-19 | Z-20 | Z-21 |
|---|---|---|---|
| Example | (Ref.) | (Ref.) | (Ref.) |
| Component K1: | | | |
| Terephthaldehyde ¹ | 0.6 | 1.9 | 0.7 |
| Diisodecyl phthalate | 15.0 | 15.0 | 15.0 |
| Component K2: | | | |
| Polymer SH-1 | 30.0 | — | — |
| Thiokol ® LP-33 | — | 30.0 | — |
| Thiokol ® LP-2 | — | — | 30.0 |
| Diisodecyl phthalate | 5.0 | 5.0 | 5.0 |
| ATH | 30.0 | 30.0 | 30.0 |
| Carbon black | 10.0 | 10.0 | 10.0 |
| Mercaptosilane | 0.9 | 0.5 | 0.5 |
| pDBSA ² | 0.9 | 0.9 | 0.9 |
| Gel time [min] | 100 | >300 | >300 |
| 7 d SCC: | | | |
| Tensile strength [MPa] | 1.0³ | n.m.⁵ | n.m.⁵ |
| Elongation at break [%] | 255 | | |
| EM 5% [MPa] | 0.75 | | |
| EM 50% [MPa] | 0.56 | | |
| Tear propagation resistance | 2.8 | n.m.⁵ | n.m.⁵ |
| [N/mm] | | | |
| +7 d 70/100: | | | |
| Tensile strength [MPa] | n.m.³ | n.m.⁵ | n.m.⁵ |
| Elongation at break [%] | | | |
| EM 5% [MPa] | | | |
| EM 50% [MPa] | | | |
| Shore A (7 d SCC) | 20 | n.m.⁵ | n.m.⁵ |
| (+7 d 70/100) | n.m. ⁴ | | |
| (+7 d 100° C.) | n.m. ⁴ | | |
| Lap shear strength (glass) | 0.4 | n.m.⁵ | n.m.⁵ |
| [MPa] | | | |
| Fracture profile | AF | | |

¹ Dissolved in heated diisodecyl phthalate
² p-Dodecylbenzenesulfonic acid
³Tacky surface
⁴ Not measurable (tacky)
⁵Not measurable (no curing, crumbly mass)

1. A curable composition comprising
a first component comprising at least one aldehyde-group-containing polymer having a hydrocarbon, polyether or polyester backbone, and
a second component comprising at least one compound having two or more thiol groups.

2. The composition as claimed in claim 1, wherein the aldehyde-group-containing polymer is liquid at room temperature.

3. The composition as claimed in claim 1, wherein the aldehyde-group-containing polymer has an average molecular weight Mₙ of from 500 to 20,000 g/mol, determined by gel-permeation chromatography against polystyrene as standard.

4. The composition as claimed in claim 1, wherein the aldehyde-group-containing polymer has an average aldehyde functionality of from 1.6 to 6.

5. The composition as claimed in claim 1, wherein the aldehyde groups of the aldehyde-group-containing polymer are each attached to an aromatic or heteroaromatic ring.

6. The composition as claimed in claim 1, wherein the aldehyde-group-containing polymer is a reaction product from the reaction of at least one hydroxyaldehyde with at least one isocyanate-group-containing polymer.

7. The composition as claimed in claim 1, wherein the compound having two or more thiol groups has 2 to 10, thiol groups.

8. The composition as claimed in claim 1, wherein the compound having two or more thiol groups has a thiol equivalent weight of from 65 to 800 g/eq.

9. The composition as claimed in claim 1, wherein the compound having two or more thiol groups is selected from the group consisting of 1,8-dimercapto-3,6-dioxaoctane, ethane-1,2-diol di(2-mercaptoacetate), butane-1,4-diol di(2-mercaptoacetate), 1,1,1-trimethylolpropane tris(2-mercaptoacetate), pentaerythritol tetrakis(2-mercaptoacetate), ethane-1,2-diol di(3-mercaptopropionate), butane-1,4-diol di(3-mercaptopropionate), 1,1,1-trimethylolpropane tris(3-mercaptopropionate), pentaerythritol tetrakis(3-mercaptopropionate), 3-mercapto-2-hydroxypropyl ether of propoxylated pentaerythritol having an average thiol-equivalent weight of 180 to 400 g/eq, tris(2-(3-mercaptopropionyloxy)ethyl) isocyanurate, and mercapto-group-containing polysulfide polymers having an average thiol equivalent weight of 250 to 800 g/eq.

10. The composition as claimed in claim 1, wherein the ratio of the number of thiol groups to the number of aldehyde groups is in the range from 1.5 to 4.

11. The composition as claimed in claim 1, wherein it comprises at least one filler selected from aluminum oxide, aluminum hydroxide, zinc oxide, and zinc hydroxide, where filler refers to a pulverulent substance that is a solid at room temperature and is not soluble in the curable composition.

12. The composition as claimed in claim 1, wherein it comprises as catalyst at least one inorganic or organic acid or a compound hydrolyzable to an acid.

13. The composition as claimed in claim 1, wherein it comprises as adhesion promoter at least one mercaptosilane.

14. A cured composition obtained from the curable composition as claimed in claim 1 after the components have been mixed.

15. The method comprising applying the composition as claimed in claim 1 as elastic adhesive, elastic sealant or elastic coating, where the first and second and any further components present are mixed with one another, and the mixed composition is applied in the liquid state to at least one substrate.
